(19) United States
(12) Patent Application Publication
(10) Pub. No.: US 2011/0143679 A1
(43) Pub. Date: Jun. 16, 2011

(54) Polling system for a moved machine component

(76) Inventors: Andreas Schuster, Wuestenrot/Neulautern (DE); Bruno Fellhauer, Brackenheim (DE)

(21) Appl. No.: 12/974,017

(22) Filed: Dec. 21, 2010

Related U.S. Application Data
(63) Continuation of application No. 11/989,288, filed on Jan. 24, 2008, now abandoned.

(30) Foreign Application Priority Data
Jul. 27, 2005 (DE) 10 2005 035 042.9

(51) Int. Cl. H04B 17/00; B23B 31/02

(52) U.S. Cl. 455/67.11; 279/126

(57) ABSTRACT

A polling system for a moved machine component comprises a polling subunit that is to be disposed at the machine component end and is provided with at least one switch which operates without power in a certain state of the machine component or a certain position of a part of the machine component, a radio transmitter unit that evaluates the switching modes of the switch and transmits the evaluated switching signals with digital radio switching signals, and an electric power source for supplying the radio transmitter unit. The polling system further comprises a radio receiver unit which is stationary relative to the polling subunit and is used for receiving and evaluating, forwarding and/or displaying the signals received from the radio transmitter unit.

This application is a continuation of Ser. No. 11/989,288 filed Jan. 24, 2008 as the national stage of PCT/EP2006/006753 filed on Jul. 11, 2006 and also claims Paris Convention priority to DE 10 2005 035 042.9 filed Jul. 27, 2005, the entire disclosures of which are hereby incorporated by reference.

### BACKGROUND OF THE INVENTION

The invention relates to a polling system for a moved machine component. Such a polling system is known, for example, from DE 103 07 565 A1. In this prior art, pressure spaces to which pressure is applied in a rotating power chuck are monitored using pressure sensors. The pressure sensors are electrically powered from rechargeable batteries that rotate along with the chuck. A stationary, non-rotating receiver is allocated to the pressure sensors. This receiver is connected to a unit for evaluating the signals received from the pressure sensor.

In this prior art, the pressure is measured by the pressure sensor, which requires electrical power and the signals generated by the pressure sensor are transmitted to the receiver by radio. Electrical power is required both to power the sensor during pressure measurement and to emit the radio waves. Because the electrical power from the rechargeable batteries is limited, the operating duration is relatively short.

The object of this invention is to provide a polling system for a moved machine component that requires relatively little electrical energy and has relatively long maintenance intervals due to its low energy consumption.

### SUMMARY OF THE INVENTION

This object is achieved by a polling system for a moved machine component, comprising a first polling subunit that is to be disposed at the machine component end and is provided with at least one switch that operates without power in a certain state of the machine component or in a certain position of a part of the machine component, a radio transmitter unit that evaluates the switching modes of the switch and transmits the evaluated switching signals with digital radio switching signals, and an electric power source for supplying the radio transmitter unit. The inventive polling system further comprises a radio receiver unit that is stationary relative to the polling subunit and is used for receiving and evaluating, forwarding and/or displaying the signals received from the radio transmitter unit.

Radio contact is constantly monitored by radio contact check signals. Within the context of the instant invention as described and claimed, the term “radio contact check signals” defines signals whose sole purpose is to verify the existence of radio contact between a transmitter and an associated receiver. As such, these signals do not contain any data resulting from the output of sensors or other measuring devices issuing measured data which changes or which can change from one transmission event to another. In consequence thereof, the radio contact check signals have minimum length and can be transmitted with very little power at defined time intervals. The mere presence of any signal whatsoever consisting of a unique bit arrangement constitutes sufficient evidence that the channel is operative. Therefore, such signals require significantly less power than data signals and allow the transmitter power source (battery) to remain operable for a prolonged period of time.

The invention has the advantage over prior art, that a switch is used that operates without power and does not consume any electrical power itself. The switch is operated in a certain state of the movable machine component or in a certain position of a part of the machine component. In the inventive polling system, electrical power is only required to evaluate the switching signals, to convert the switching signals into digital radio switching signals and to transmit the digital radio switching signals. The power source of the polling subunit at the machine component end therefore only supplies power to the radio transmitter unit. As the signals of the switching modes transmitted are not analog signals but already evaluated, digitized radio switching signals, the energy consumption of the transmitter unit is reduced. Transmission of digital signals can be performed relatively fast as compared with analog signals and therefore with energy savings, that is, in the range below one millisecond.

In the inventive polling system, the radio receiver unit receives and evaluates, forwards and/or displays the digital signals of the radio transmitter unit. In particular, the radio transmitter unit can comprise an interface with the machine control that controls the moved machine component.

To reduce the energy consumption of the radio transmitter unit still further, the invention can include a radio transmitter unit that is structured such that the radio switching signals are only transmitted when the switching mode of the switch changes. In this case, electrical power is only required to transmit radio signals when the switching mode has actually changed.

In a further advantageous embodiment of the invention, the radio transmitter unit is structured such that it monitors the status of the power source and transmits relevant energy check signals and that the receive unit evaluates, forwards and/or displays these signals. This permits monitoring the status of the power source. It can be detected if the power source is too weak and/or if there is a fault in the power source. If necessary, protective measures can be taken, such as ending the motion of the machine component.

According to the invention, the radio transmitter unit can also be structured such that the radio contact check signals are transmitted and that the receiver unit evaluates, forwards and/or displays these signals. In this way, it is possible to check whether adequate radio contact exists. If the radio contact check signals are not received, an alarm may be generated, forwarded and/or displayed, for example.

The power source check signals and/or the radio contact check signals are used, in particular, to increase the functional reliability of the polling system. This enables reliable and timely detection of a polling system failure.

To keep the consumption of electrical power low according to the invention, the energy check signals and/or the radio contact check signals can be polled and/or transmitted at regular intervals. In particular, the time intervals can be set depending on the safety relevance of the moved machine component. If the power source used is a battery, it may be sufficient to transmit the power source check signal once every few seconds. The power source check signal and/or the radio contact check signal is advantageously transmitted as a digital signal by the radio transmitter unit.

In a further embodiment of the invention, the radio transmitter unit can be switched into an operating mode, a setting mode and a storage mode. The operating mode is used during normal operation of the machine component and is especially energy-saving. The setting mode is used for setting and calibrating the polling system, with the possibility of using optical signal transmitters in addition to the radio signals to represent optically the transmission of the radio switching signals or the reception of the radio switching signals. In setting mode, higher energy consumption is therefore accepted. In the third mode (storage mode) the power source is electrically disconnected from the radio transmitter unit, so that no consumption of power can occur. Provision of these three modes can therefore further optimize power consumption.

Switching between the modes can be performed by means of a contactless magnetic switching element. The provision of a contactless magnetic switching element has the advantage that no corrosion occurs if the radio transmitter unit is stored for a long time and the functional reliability of the polling system is increased. The magnetic element could be a magnetic pin, for example, with different positions of the magnetic pin setting different modes.

According to the invention, the power source may advantageously be a battery or an autonomous power generator that generates electrical power from available external energy. The power generator may be solar cells.

According to the invention, the switches used may be momentary-contact switches, maintained-contact switches, pressure switches or magnetic proximity switches. The decisive property of the switches is that they function without electrical power.

The object of the invention stated above is achieved by a machine component that can be disposed such that it can rotate about an axis of rotation and that has the form of a power chuck with a chuck body carrying clamping jaws in the radial direction. This power chuck comprises an inventive polling system whose polling subunit is located in the chuck body. Such a power chuck has the advantage that, by means of the polling system, for example, the clamping pressure with which the clamping jaws hold a workpiece and/or the position of the clamping jaws can be polled and transmitted to the radio receiver unit with relatively little electrical power.

In this case, it is advantageous if the switch operating without power is a pressure switch for monitoring the clamping pressure state of the clamping pressure equipment and/or the clamping position of the clamping jaws. Such a pressure switch is, for example, operated by the prevailing clamping pressure and can, for example, be set depending on the intended clamping pressure.

An inventive power chuck can be characterized in that the radio transmitter unit comprises an antenna that protrudes in the axial direction out of the surface of the chuck body that extends perpendicularly to the axis of rotation. This ensures that optimum radio contact can be maintained between the radio transmitter unit in the chuck body, or rather the associated antenna, and the radio receiver unit.

The antenna can have the form of a helical spring and protrude along an, in particular, curved line out of the surface of the chuck body that extends perpendicular to the axis of rotation. An antenna thus constituted has proven very advantageous in practice because, due to the helical form of the antenna and the protrusion of the antenna out of the surface of the chuck body that extends perpendicularly to the axis of rotation, radio signals can reliably be transmitted optimally with low transmission power.

According to a further embodiment of the invention, the radio transmitter unit together with the antenna and power source can be disposed completely within a plastic casting. This protects the radio transmitter unit from external influences, such as cutting emulsions and/or chips.

The object of the invention stated above is also solved by a machine component that can be moved by means of a handling system in the form of an automation component that comprises an inventive polling system, the polling subunit being disposed in or on the automation component and the radio receiver unit being stationary with respect to the automation component. The automation component is therefore moved in three dimensions using a handling system, for example, using a robot arm. By means of the inventive polling system that can be disposed in or on the automation component, certain positions and/or certain states of the automation component or parts of the automation component can be polled.

As automation components, in particular, gripping or clamping fixtures can be used that comprise a base body and jaws disposed in the base body such that they can move. With the inventive polling system, for example, the positions of the jaws can be polled and communicated to the radio receiver unit. The automation component may also be a swiveling unit that has a swiveling element located in a base body such that it can rotate. With the polling module, it is possible, for example, to poll and communicate the position of the swiveling element. Moreover, an inventive automation component can be a quick-change system. In this case, the invention can be used to poll whether the tool has been changed. Moreover, the automation component used may be collision or overload protection that, for example, effectively protects a robot or robot manipulator against damage due to collision or overload conditions. In this context, the inventive polling system can acquire or communicate the occurrence of a collision or overload condition. According to the invention, an automation component can also be a linear drive and/or a lift drive. In this case, the inventive polling system is used to poll and communicate the position of the lift element moved by the drive.

According to the invention automation components other than those mentioned can also include an inventive polling system.

Further details and advantages of the invention can be seen from the following description in which the embodiments shown in the figures are described and explained in more detail.

### BRIEF DESCRIPTION OF THE DRAWING

FIG. 1 Various inventive automation components;

FIG. 2 A radio transmitter unit with two switches of an automation component according to FIG. 1;

FIG. 3 A second radio transmitter unit for a power chuck;

FIG. 4 A power chuck incorporating a radio transmitter unit according to FIG. 3; and

FIG. 5 A radio receiver unit for a radio transmitter unit according to FIG. 2 or FIG. 3.

### DESCRIPTION OF THE PREFERRED EMBODIMENT

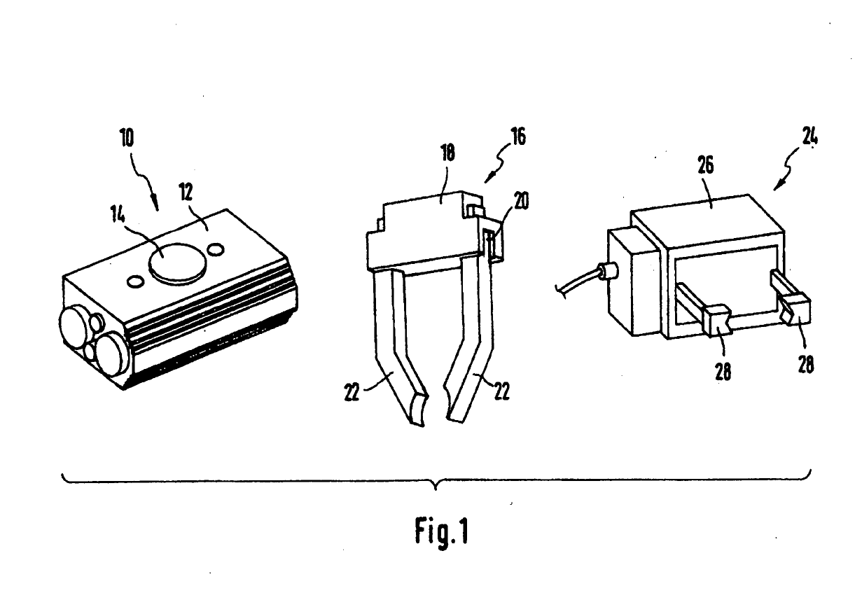

FIG. 1 shows various automation components. Firstly, a swiveling unit is shown that comprises a base housing 12 and a swiveling element 14. Secondly, a parallel gripper 16 is shown that comprises a base housing 18 and two jaws 20 that can be moved further together and further apart in the base housing and gripper fingers 22 on the jaws. The third automation component is a swivel gripper unit 24 shown in FIG. 1 that has a base housing 26 and two gripper fingers 28 that can be swiveled further together or further apart. The automation components shown in FIG. 1 can, for example, be disposed such that they can be moved in three dimensions by means of handling systems. The machine component parts 10, 16, 24 can comprise polling systems for polling the orientation or position of the moved components 14, 22, 28.

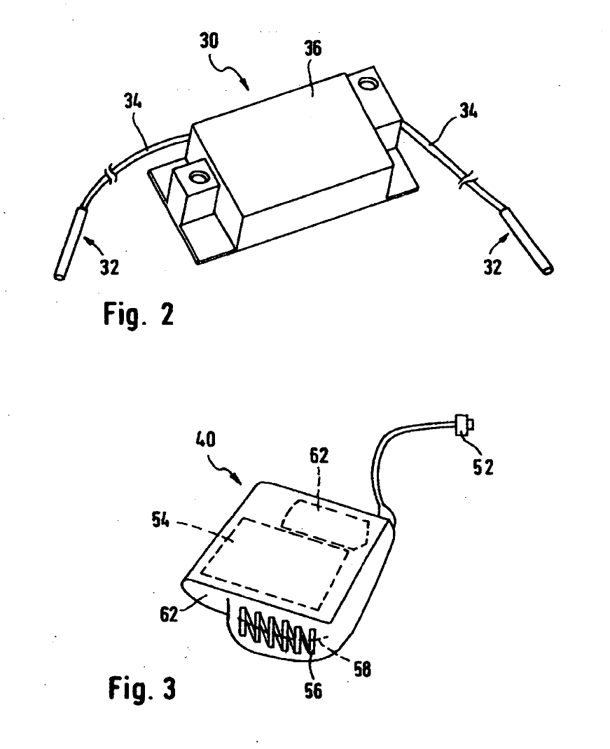

Such a polling system comprises a polling subunit at the automation component end that can be disposed, for example, in the case of the swivel unit 10, on the base housing 12; in the case of the parallel gripper 16, on the base housing 18; and in the case of the swivel gripper 24, on the base housing 26. Such a polling subunit is shown in FIG. 2 and identified with the reference number 30. The polling subunit 30 comprises two switches 32 that operate without power, which are connected to a radio transmitter unit 36 by means of the electrically conducting cables 34. The switches 32 can, for example, be constituted as magnetic proximity switches in the form of Reed switches that operate when a ferromagnetic element or permanent magnet enters their detection range. Such switches do not require a power supply.

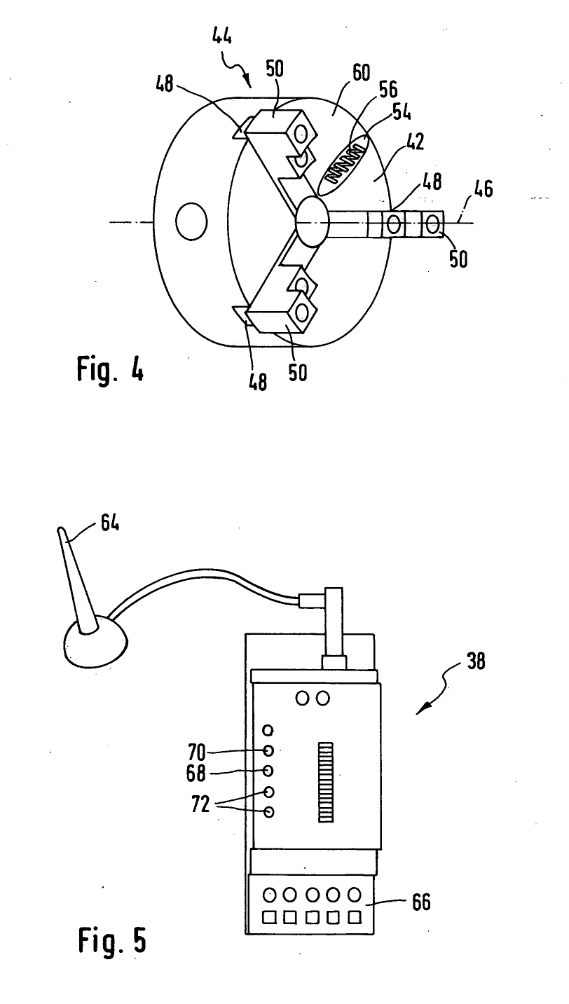

The radio transmitter unit 36 evaluates the switching signals of the switches 32 and transmits digital radio switching signals, for example, in the form of radio telegrams to a radio receiver unit 38 shown in FIG. 5. The polling subunit 30 shown in FIG. 2 also comprises a power source (not depicted) in the form of a battery. A power generator, such as solar cells, can be used instead of or in addition to the battery.

Because switches 32 do not require electrical power and previously evaluated, digital switching signals are transmitted, the radio transmitter unit requires relatively little electrical power. For example, if one digital radio signal per second is transmitted by the radio transmitter unit, the life of the conventional batteries that are available today may be five to ten years. Such a long battery life results, in particular, when the duration of the transmitted digital radio switching signals is shorter than one millisecond.

FIG. 3 shows a second embodiment of a polling subunit 40 to be disposed in a moved machine component in the form of a power chuck 44 with a chuck body 42 shown in FIG. 4 such that it can rotate about an axis of rotation 46. The chuck body 42 comprises jaw guides in the radial direction for clamping jaws 50 that can be moved in the radial direction. The clamping jaws 50 can hold workpieces centered for machining by turning.

As shown in FIG. 3, the polling subunit 40 comprises a switch 52 that operates without power, in particular, a pressure switch for monitoring the clamping pressure state of clamping pressure equipment with which the clamping pressure of the jaws 50 is produced. Moreover, the polling subunit 40 comprises a radio transmitted unit 54 for evaluation of the switching modes of the pressure switch 52 and for transmission of the evaluated switching signals by means of digital radio signals. The radio transmitter unit 54 comprises an antenna 56 constituted as a helical spring that protrudes along the curved line 58 out of a surface 60 of the chuck body 42 that extends perpendicularly to axis of rotation. The curved line 58 along which the antenna 56 extends can, in particular, be clearly seen in FIG. 3. The surrounding edge 62 facing the antenna 56 is substantially flush with the surface 60 when the polling subunit 40 is built into the chuck body 42. Such a disposition has the advantage that radio signals can be transmitted optimally with comparatively low power consumption through the antenna 56 that is protruding from the surface 60 even when the power chuck 44 rotates rapidly.

In FIG. 4, the polling subunit 40 is built into the power chuck 44, or rather into its chuck body 42. For this purpose, the chuck body 42 includes a recess matching the external dimensions of the polling subunit 40. As already explained, when built in, the antenna 56 protrudes in the axial direction out of the surface that extends perpendicular to the axis of rotation 46.

As can also be seen from FIG. 3, the polling subunit 40 comprises a power source in the form of a battery 62. The battery 62, the radio transmitter unit 54 and the antenna 56 are completely encased in a plastic casting. When built in, the pressure switch 52 that is connected via a cable to the radio transmitter unit 54 is in or on the pressure space of the clamping pressure equipment.

As already explained, FIG. 5 shows a radio receiver unit 38 that is stationary and comprises an antenna 64 with which the digital radio signals are received from the radio transmitter unit 36 according to FIG. 2 and/or from the radio transmitter unit 40 according to FIG. 4. The radio receiver unit 38 has an interface 66 for connection with a machine control, in particular, with the machine control that controls automation components 10, 16, 14 according to FIG. 1 and/or the power chuck 44 according to FIG. 4 transmitted digital radio switching signals can also be polled with the radio receiver unit 38.

The radio transmitter units shown in the figures can be structured to monitor the status of the power sources and transmit relevant power source check signals. If the power source check signals fall below a certain value, this can be detected, displayed and/or forwarded to the machine control by the radio receiver unit 38.

Moreover, the radio transmitter units 36, 54 are constituted such that they transmit radio contact check signals that are received by the radio receiver unit 38. If regularly transmitted radio contact check signals are not received, this can result in an alarm.

The radio receiver unit 38 has various indicator lamps, that is, a power source indicator lamp 68 of the radio transmitter unit 40, a radio contact check lamp 70 and two switching contact indicator lamps 72, to check the switching modes of the switches 32, 52. Moreover, an indicator lamp 74 is provided for the power supply of the radio receiver unit 38.

We claim:

1. A polling system for a moved machine component, the system comprising:
a polling subunit disposed at the machine component and having at least one switch that operates without power in a certain state of the machine component or a certain position of a part of the machine component, a radio transmitter unit that evaluates switching modes of said switch and transmits evaluated switching signals using digital radio switching signals, said radio transmitter also emitting radio contact check signals, said radio contact check signals confirming radio contact only and being otherwise devoid of changing data information content, and with an electric power source for supplying the radio transmitter unit; and
a radio receiver unit that is stationary relative to said polling subunit, said radio receiver unit receiving and evaluating, forwarding and/or displaying signals received from said radio transmitter unit, wherein said radio transmitter unit is structured to only transmit radio switching signals upon a change in a switching mode of said switch, said radio contact check signals being transmitted at regular time intervals, wherein said radio receiver unit evaluates, passes on, and/or displays said radio contact check signals for prompt recognition of polling system failure.

2. The polling system of claim 1, wherein said radio transmitter unit is structured to monitor a status of said power source and to transmit relevant power source check signals, wherein said radio receiver unit evaluates, forwards and/or displays said power source check signals.

3. The polling system of claim 2, wherein said radio transmitter unit is structured to poll and/or transmit power source check signals at regular time intervals.

4. The polling system of claim 1, wherein said radio transmitter unit can be switched into an operating mode, setting mode and storage mode.

5. The polling system of claim 4, wherein switching between modes is performed by means of a contactless magnetic switching element.

6. The polling system of claim 1, wherein said power source is a battery or power generator.

7. The polling system of claim 1, wherein said switch is a momentary-contact switch, maintained-contact switch, pressure switch, or magnetic proximity switch.

8. A machine component in the form of a power chuck, the machine component comprising;
a chuck body;
clamping jaws borne by said chuck body to rotate around an axis of rotation;
a polling system having a polling subunit disposed at the machine component and with at least one switch that operates without power in a certain state of the machine component or a certain position of a part of the machine component, a radio transmitter unit that evaluates switching modes of said switch and transmits evaluated switching signals using digital radio switching signals, and an electric power source for supplying said radio transmitter unit, said radio transmitter also emitting radio contact check signals at regular time intervals, said radio contact check signals confirming radio contact only and being otherwise devoid of changing data information content; and
a radio receiver unit that is stationary relative to said polling subunit, said radio receiver unit receiving and evaluating, forwarding and/or displaying signals received from said radio transmitter unit, wherein said radio receiver unit evaluates, passes on, and/or displays said radio contact check signals for prompt recognition of polling system failure, said polling subunit being disposed in said chuck body and said radio transmitter unit comprising an antenna, shaped like a helical spring, that protrudes in an axial direction out of a surface of said chuck body that extends perpendicularly to the axis of rotation, wherein said radio transmitter unit, together with said antenna and power source, is completely encased within a plastic casting.

9. The power chuck of claim 8, wherein said antenna extends along a curved line.

10. The power chuck of claim 8, wherein said switch is a pressure switch for monitoring a clamping pressure state of clamping pressure equipment and/or a clamping position of said clamping jaws.
